(19) United States
(12) Patent Application Publication
(10) Pub. No.: US 2002/0016910 A1
(43) Pub. Date: Feb. 7, 2002

(54) Method for secure distribution of documents over electronic networks

(76) Inventors: Robert P. Wright, Van Nuys, CA (US); John A. Macoviak, La Jolla, CA (US)

Correspondence Address: LEARY & ASSOCIATES, 505 W OLIVE AVE, SUITE 330, SUNNYVALE, CA, 94086, US

(21) Appl. No.: 09/780,037

(22) Filed: Feb. 9, 2001

Related U.S. Application Data
(60) Provisional application No. 60/181,295, filed on Feb. 9, 2000.

(51) Int. Cl. H04L 9/00; G06F 17/60

(52) U.S. Cl. 713/150; 705/51

(57) ABSTRACT

The present invention relates to methods for secure distribution of documents over electronic networks. The method may be implemented over public private and/or semi-private electronic networks, including computer networks, intranets, the Internet or combinations thereof. The method includes novel clueing and encryption mechanisms for secure transmission of documents and other electronic data. The method may further include steps for recording the transmitted document in a tangible medium and secure delivery of the document to an intended recipient.

### CROSS REFERENCE TO OTHER APPLICATIONS

This application claims the benefit of U.S. Provisional Patent Application, Serial No. 60/181,295, filed Feb. 9, 2000.

### BACKGROUND OF THE INVENTION

Today encryption is under-used and privacy issues often become relegated to the hope that no one may intercept otherwise confidential information on the internet all for the sake of convenience.

To be addressed in this invention are electronic communication confidentiality issues that traditionally to a fault and currently exist wherein privacy or semi-private usage of Internet sites and digital communications such as electronic mail and voice mail systems are concerned. Highly secure encryption platforms have been cumbersome to apply broadly and inexpensively without having all parties using the same software. Virtual private networks currently attempt to approach some of these issues but to date have been inaccessible from outside hard wired facilities without installing special software on specific hardware having Internet capabilities. This results in difficult access from outside by privileged parties. To a fault virtual private networks have relied on firewalls creating a closed architecture. Secure digitally based communications, i.e. electronic voice communications and mail have relied upon all parties having the same software installed on their hardware for encryption processing. A goal of the current invention is to overcome these problems.

The major potential benefit of encryption is that it allows users the ability to store or transfer digital information in a form that does not allow that information to be revealed to third parties. Encryption technology allows digital information to be combined with a known series of digits (a key) and then operated upon with a mathematical function in a bit-wise manner, to render the information unintelligible. However, the inverse mathematical function may be applied, in combination with the encryption key, to return the information to its original, readable state. The security of encryption typically depends only upon the secrecy of the key, and not upon the secrecy of the mathematical algorithm. When the same key is used for both encryption and decryption, this is known as a symmetric encryption algorithm.

Public Key encryption differs significantly from symmetric encryption. In Public Key encryption, users maintain two separate but related keys, known as the public key and the private key. Various algorithms are used to derive the two related keys for any given user. To encrypt digital information, the user's public key is combined with a mathematical algorithm and the information, to render the information unintelligible.

Once encrypted with a public key, data may not be decrypted except with the related private key. In this way, a user may distribute one's public key to the general public, and allow them to encrypt data for user purposes. Upon receipt of said data, the user may use a private key, along with a decryption algorithm, to return the encrypted data to its original, readable state.

One problem with Public Key encryption is that, while any person may encrypt data with a user's public key, only the user's private key may be used to decrypt data. If a user wishes to securely share information with another user who does not possess a public key, the first user must encrypt that data with her or his own public key, then allow the second user access to that private key in order to decrypt the data. The major problem with this is that once the second user possesses the first user's private key, the second user may decrypt any data that is ever encrypted with the first user's public key. This does not easily facilitate the exchange of data with users who do not possess their own key pairs. Thus, if many people wish to share data, they must all possess public/private key pairs, and they must exchange public keys among themselves. Only then may each user encrypt data for any other user. Broad-scale public key cryptography is difficult to implement, mainly due to the large infrastructure required to distribute and maintain these keys securely. To date, public key architectures have centered around specific hardware and/or significant memory requiring software dependent applications, meaning that all persons within an information exchange group must all possess the same hardware and/or software on their systems.

A second goal of the present invention through newly described herein unique software, hardware and methods of doing business is based on enabling digital electronic and physical distribution methods for confidential mail, documents, receipts, warranties and goods. These may be used to enable deliveries the same day or some time thereafter of confidential documents and securely protected goods across substantial distances. The systems are to be prompted, organized and enabled through unique electronic software and hardware systems that will address improving the competency and efficiency of electronic and physical mailing systems.

Needs which the systems described in this invention refer to are the need for more efficient flow of physical confidential mail. Also is the need for technology to enable more people to have electronic mail and goods routing conveniences with minimal knowledge of electronic device usage and no or minimal personal hardware. Critical location of and the security of such systems will be essential and would require unique hardware and software to be enabled.

### SUMMARY OF THE INVENTION

Newly described clueing, encryption and other newly described mechanisms and systems will address the problems associated with gating and controlling authorized access to wired or wireless secure, partially secure and non-secure public, private and semi-private electronic systems. User access to internet sites, semi-private, private or public network systems and all forms of digital electronic communication systems such as voice or tone, telephone networks, telegraphic, fax or electronic mail networks and Internet based sites and servers having confidential protected data would be improved by these systems.

A specific goal of the invention is to describe novel clueing and encryption mechanisms. These are to be applied each solely or in combinations to include non-clued and non-encrypted combinations, and servers for gating and controlling public, semi-private or private access to certain or all confidential data to be accessible through the internet without specific software other than modem browser capabilities. Internet sites, electronic mail systems and sites, (virtual through the Internet or real hardwired) public, semi-private, private network systems will be enabled with selectively penetrable authorized public, private and semi-private portals. Applications of the systems described herein allow an encrypted or non-encrypted non-traceable or traceable environment between a secure or non-secure server and an otherwise secured or unsecured client. This may allow client access to electronic mail whether by Internet or other wireless means of communication including telephone, radio, telegraphy, and other privileges to utilize the capabilities of selected resident server or remote client based programs. This should be able to occur seamlessly and independently of additional client user software beyond standard Internet browser capabilities from any computer anywhere.

Applications of such technology using highly encrypted processes as part of the application compared to today's relatively cumbersome encrypted transmissions would better allay anxiety over security threats for multiple party and business uses. Today's encrypted transmissions generally require expensive, large user memory requirements for specialized software installations by at least two parties. These parties must actively exchange encryption keys or at least have specialized software on each client, which multiplied by several parties who wish to have secure transmissions adds further to the costs and inefficiencies of such systems.

Server-client systems are to be described in the current invention that would allow desirable seamless encryption for electronic mail would also become more functional for those concerned with maintaining privacy yet increasing the utility of their virtual private networks. The current invention calls for having authorized Internet portals through firewalls to enable invited parties to have limited selective penetration. Such a system could allow privileging of multiple users over time to have determinable differentially functional accesses to partial or complete sets of data that might be stored or uploaded to those servers during specified time frames. It would be desirable to enable such encrypted servers to seamlessly allow: access control capabilities for specific complete or partial upload and download privileges and access controlled capabilities for single, dual or multiple party-edit privileges for data transfer and storage via the internet. For larger systems this may require matrix capabilities which would allow prescribed securely encrypted network embodiments with certain components being unencrypted, mixed with possibly otherwise secure and, or unsecured modalities for indelible or transient data storage, transmission and manipulation capabilities. It would further be desirable to have users of such networks enabled by server based systems to allow remote access from any of today's internet browser capable computers independent of any other specific client software or hardware capabilities by simply using authorized portals.

The current problems of privacy and security also have implications in limiting the use of network systems that can be resolved with highly authenticated efficient “digital signatures”. Seamless hardware and software as described in the invention have the capabilities for signature, hashing authentication, and notarization in an encrypted environment. These will become applicable in day to day transactions that would lead to significant improvements concerning rapidity of delivery for confidential commercial and legal applications and for completing such transactions more efficiently and completely. Such benefits become apparent when applied alone or as part of a larger system of authentication of such hashed and authenticated materials potentially requiring or allowing digital signatures and notarizations. This may be exemplified, as is the case when confidential legal documents such as patent applications are to be electronically transmitted electronically to the patent office or any other such document to any other such chosen legal or confidential entity. That may occur directly through pre-arranged hardware and software resident service. Or it may go to a secured intermediary in geographic proximity to the entity that may confidentially print and package such items for immediate delivery to highly trafficked entities that may require printed applications and documents to be provided.

The invention disclosed herein allows users to efficiently at less expense than is associated with biometrics authentication or in conjunction with that technology, to take advantage of public-key encryption and digital signature technologies to encrypt and digitally sign their private information. That information may be stored in encrypted form on internet-resident servers, so that the information is available at all times and from any computer capable hardware that is Internet-enabled.

The invention provides the capability to confidentially and seamlessly integrate upload, download, encryption, and storage functions through a familiar web-browser interface, thus eliminating the need for users to install special hardware and/or software on their computer system. Given this specific hardware and software independence, coupled with a unique method for the distribution and storage of encryption keys, users are freed from dependence upon any single machine from which to access their stored data. Additionally, the unique semi-private key technology, which is an integral component of the invention, allows users to freely distribute subsets of their private, encrypted data to other parties, without being forced to surrender their own private keys to perform decryption of that data.

A part of the present invention addresses these Public Key encryption problems. First, users may freely exchange information by utilizing a new technology, semi-private keys. Semi-private keys are simply secondary public/private key pairs implemented in such a way as to appear to the user to be unique new key types which allow for distribution of information to users who do not possess their own public key, without having to reveal one's own private key. Semi-private keys allow users to share limited numbers of encrypted documents with other parties, while still ensuring that any data encrypted with their own public key remains secure.

For purposes of this invention the main information bank (server) has high availability via standard Internet connectivity protocols. In one particular configuration, this server is responsible for storing all encrypted data files for each user, and also stores the user's public key and private key, in a secure form.

Clueing may to be used to allow the proprietor or sender of confidential data to give access to another individual to that confidential data. The data may be transmitted by any wired or wireless electronic means including telephonically. In an embodiment instant or non-instant messaging of such devices may use clueing to allow such messages or access to electronic networks to be accomplished. The proprietor or sender through electronic mail or file transfer protocols, or telephonic to digital, or telephonic to person to digital means, may compose whatever material they wish encrypted. A proprietor or a sender may through single or combination applications establish a clue to allow the recipient to decrypt the material. A clue may be an answer requiring a question, completion of a map or drawing, a puzzle, a series of questions, known or partially revealed musical tunes or tones which may or may not require a musical response, trivia questions, an account number, mathematical or logical questions. Other possibly pre-arranged identifying information or clues that would be known to both parties and in fact may appear false or illogical but which are unlikely to be answered by an eavesdropping party may be applied. The degree of confidentiality desirable for the proprietor or sender to set is determinable in their own mind or from a myriad of clues that this mechanism can generate for them. One embodiment of the invention provides for election of clues and responses from a computerized generator to include statistical weights to the clue and response solution process. Once the clue is set and the data is encrypted, a message may be electronically sent to the recipient party or parties. They simply may receive a message with or without a direct link back to the client server, or an Internet server, a virtual private network or other similar networks or electronic mail or messaging systems holding the encrypted data or unencrypted data that an individual wishes to become encrypted. Once they successfully answer the apparent clues they are given access to only the data which the proprietor or have designated. Certain privileges for handling the data by the recipient may have been authorized or be authorized upon a request. The system may lead the recipient(s) directly to the proprietor or sender or may lead the recipient through a clued maze to get authority electronically determinable authority to download, edit, print or forward or otherwise enhance, alter or manipulate that data. The recipient may receive and respond to the electronic message using the same server electronic messaging system or any other non-identical electronic mail or access system. These may include, wired and or wireless systems, voice or digital system, or any other not yet described communication means, with or without other keying or identifying information.

Encryption and decryption may be accommodated in one of many ways. One encryption methodology may entail the utilization of Java code running in the client browser to make use of the client processor to handle the encryption processing. In this example, the server returns the requested encrypted document to the client computer, along with the user's encrypted private key. Once the user has entered the correct key-phrase, a client-side Java engine decrypts the user's private key, then uses this private key to decrypt the data file. Likewise, an example implementation of the decryption process includes the server returning the users' public key to the client browser. This key is then used to encrypt the user-selected data file, and finally, the data file is uploaded to the server for indelible storage.

To ensure data integrity and indelibility, a verification process may be used to indicate that the file was received correctly after upload/download. A one-way hash of the encrypted file may be passed along with the file at upload or download. This hash is then compared to a re-hash of the received file. If the two hash values match, there is a high probability that there were no file transmission errors.

Once a user has downloaded and decrypted a file on any computer, that individual should ensure that information's security by erasing the file from any local disks. Most modern operating systems do not actually eliminate the file from the disk when the user requests that the file be deleted. Instead, the location of that file is simply removed from the disk's allocation table. This means that the file still exists on the disk in a decrypted form. With the proper software, virtually any user may easily recover file that has physical access to the computer. For this reason, the present invention includes facilities to ensure that files are actually destroyed when the user is finished using them, by overwriting the files with useless data.

Normally, it is very difficult to positively and definitely identify a remote computer user. Without absolutely reliable identification, a digital signature provides little legal weight; anyone may claim another person's identity, establish a digital signature with that identify, and attempt to sign documents under this alias. Further, establishing positive user identification requires that trusted administrators actually meet the user and examine some form of government-issued identification. Clearly, digital signatures must be associated only to users who are known to the certificate authority, however, the requirement that the certificate authority actually visually confirm the user's identity is very burdensome. A more efficient solution is required for this problem.

A fundamental part of the present invention involves the establishment of user trust levels to establish confirmed user identity, and to associate a digital signature with that trusted user. The user authentication system described herein allows for specific methods of establishing user trust and identification. These methods allow trusted institutions and information-provider partners to submit identity-verifying information to a user's personal vault. Once received, system administrators may examine this information and, if appropriate, increment the user's trust level. Once enough “trust points” are established, the user is established as “trusted” and her or his server-issued digital signature is considered valid and binding as it pertains and is associated with a rating system which provides concerned parties potential thresholds for rejection or acceptance of such authenticated transactions. In this way, for example, a user's identity may be remotely determined for the purpose of assigning a digital signature to that identity.

A variety of information exchange and storage systems may be implemented using elements of the present invention. These systems will enable secure exchange and storage of information for a single user, groups of users, businesses, business partners, governments, and other institutions. Additionally, implementation of the present invention (in one of many possible forms) provides for the indelibility, availability and validity of information exchanged/stored.

A second goal of the present invention through newly described herein unique software, hardware and methods of doing business is based on enabling digital electronic and physical distribution methods for mail, documents and goods. These methods, hardware and software may be used to enable deliveries the same day or some time thereafter of confidential documents and securely protected goods across substantial distances. The systems are to be prompted, organized and enabled through unique electronic software and hardware systems that will address improving the competency and efficiency of electronic and physical mailing systems.

An embodiment of the invention is integrally dependent on the above disclosed inventions and is to enable confidential physical distribution of packages, mail or other goods and the messaging and communication means to further enhance it breadth and facility of application. Described are the electronic software, hardware, appliances and physical means to implement a hybrid of electronic and physical or solely electronic delivery of documents and goods or vouchers to goods, mailing and delivery systems. These systems are comprehensive in their capability and far reaching in their effect on daily business and personal life at local, national and international levels of application

Described are functional physical hardware and remotely (including global international sites) both electronically and physically accessible specific hardware and software-enabled semi-private, private or public mail depots, kiosks and physical mailboxes. Their presence in key physical locations determines the impact of the distribution system in this invention. Described are depots having the most comprehensive capabilities for receiving and processing electronic media mail, messages, documents and goods for pickup or delivery.

Depot functions may include contact of a recipient by phone or other electronic means indicated by the sender. Delivery of messages by personnel or electronic means, mail, or documents in the form of electronic disks, fax or physical imprinting upon printable surfaces may be personalized on a provided stationery and indelibly sealed when that is required. Hardware that perform these tasks are constructed as to be secure and highly efficient in confidential printing and sealing functions. So as not to create the need for physically handling non-sealed secure information included are means for shredding or otherwise destroying by over writing or chemically treating any jammed or poorly produced document packages prior to resetting or physically handling such physical systems and items therein.

An embodiment of the invention uses secure systems of delivering disks with encrypted or non-encrypted messages. If encrypted messages are sent in electronic format they may be transferred to the addressee in automatically printed and confidentially sealed envelopes as disks or in other electronic formats or if required in their decrypted forms. If encrypted material is delivered a sender has the capability as described herein to deliver intelligible instructions to a recipient as to the means by which to decrypt such material. Couriers can do certification of receipt of the disk or physically printed mail. Disks may have written instructions or a message on the disk or in the envelope as to have to electronically handle the disk.

Another embodiment of such an application would be to have a sender electronically forward material or physically report to a depot and there electronically by voice or other electronic mean compose an application. A disk-deposit or scan-in or use another electronically formatted deposit mechanism will allow such compositions. The application may be delivered to another Internet site with receipt capabilities or to a locale having another depot or related kiosk or public or private electronic mailbox. From said devices notification to a recipient would be made as per senders instructions possibly including fax, pager, telephone, electronic mail, or courier delivery of said notification or such good or package. The recipient may chose to receive the mail in any electronic form or physically by pick-up or delivery.

Another function of the depot and the depot like devices may be electronic signature by any type of identity verification or by means described in this invention or by any other identification means that may exist. If required notarization may be facilitated by these same means. Recipient accessible electronic capabilities for return communication to the depot or kiosk, mailbox or vendor or sender may be applied to enhance further these above described applications, methods, hardware, appliances and software.

Kiosks enabled by the systems described herein within publicly accessible areas for businesses and the public can serve some or all of the functions of the depots. Depots and kiosks may house the necessary software and hardware including Internet connectivity, printer-packager units, and uniquely designed electronic disk processing units. The depots and kiosks may serve as pick-up points for packages of goods there deposited or electronically created mail to be delivered to addresses in the area in confidentially printed and packaged physical form. Once notified individuals may pick-up their own packages or await delivery by proprietary agents or agencies contracted to perform those duties depending upon sender or vendor or recipient instructions or requests.

Another embodiment is to have a kiosk placed physically in a distribution like mail deposit boxes on a street comers or other public areas for delivery of goods or documents. A kiosk could accept a package an electronic disk or a request for a fax or email to be sent to someone's electronic mail. It may o scan documents, faxes, emails, voice mails or other electronic content to physically create and seal the documents in an envelope for remote or local depot or kiosk for package pick-up or courier delivery. A depot may electronically forward them to a recipient with or without return of the original documents or electronic disks by physical means to the sender.

In one embodiment the invention may also be used for remote from sender to a nearby to recipient vendor a request for a good or service package for a specified remote recipient. Depots and kiosks may serve as pick-up points for items brought there from surrounding vendors by physical means electronically coordinated by described herein electronic means. Pick-up of such goods can be arranged by a recipient through persons or businesses they may delegate to do so. Either a depot or kiosk may serve as a secure decryptor, printer, collator, packager and dispenser for packaged documents or goods. Vendors or their couriers may deposit goods for packaging and dispensing at a 24 hour, 7 day a week secure depot or kiosk. Messaging to and from a recipient, a vendor and a sender may be electronically accomplished by the secure communication means described on the invention.

Electronic public or private mailbox hardware embodiments are described and enabled by the software disclosed in this invention may also perform certain or all functions of a depot in embodiments which are configured to emulate these functions.

Another embodiment is of a physical electronic mailbox at a business office or home, which is capable of securely receiving, printing and enveloping or packaging electronically mailed documents or electronically forwarding them to another electronic or physical address documents. These may or may not be sent through described depot and kiosk systems.

For addressing, transferring or distributing, electronically or physically, files such as legal documents, receipts, warranties, insurance policies, benefits packages, tax returns or other highly confidential information which are to be protected from alteration and are authenticated or packages to the likes of government agencies, professional experts, businesses, clients, or persons alone, through the encryption, hashing and clueing techniques described in this invention are secure the implement digital electronic, physical printing, packaging and distribution means to ensure confidential transfers and indelible documentation's of such transactions. Enabled are secure electronic and physical messaging, transfer, electronic and physical storage processes that may be controlled through voice mail systems, pagers, telephones and any electronic or physical communication means. These processes are to enable people or businesses or governmental entities to contact others through initially electronically composed requests by electronic voice transmissions, electronic or physically created document programs. Electronic messaging to electronic or to physical messaging means or through fax, scanner, telephone or any other electronic means may be applied. These processes can be downloaded and printed at a personal or business physical site or electronically accessible Internet or intranet type-sites designated to be or not to be handled by personnel or electronic mailbox printers, kiosks or depots. Non-secure communications may also take place within the described systems.

Documents are enabled to be opened securely from any browser or can have relayed notification to a recipient by telegram or notification to contact Internet based services by voicemail to message machine, pager or telephone or by fax or by combinations of messaging techniques.

Encrypted document files may be put onto a disposable or non-disposable digital disk or printed and delivered on the encrypted disk or in printed form. If on a disk the individual may go to an Internet site or other physical repository site to obtain or apply the authorized key to decipher the encryption. This process may use a clueing system.

An embodiment of any of the transactions newly enabled by this invention includes the transmission electronically of authenticated indelible electronic receipts or warranties or other legal documentation pertinent to the transaction. These may include electronic payment, receipt, warranty and full transaction authentication and return though electronic and or physical means indelible recordings of such transactions. Business or personal receipts from the likes of hotels, train, cabs, restaurants and from merchandise vendors may be electronically relayed indelibly to what ever email or internet site chosen by the users of these and other purchase of goods or services by whatever payment means. Hardware or appliances that are physically mobile or fixed may facilitate these transactions.

Another embodiment application of the invention is the aggregation of local merchants' in-stock items that can be made readily available at specified times for delivery or pick up. The software can obtain a vendor price or an asking price, which may or may not be countered with a buyer bid price. The distance from an individual buyer or recipient of goods and comparative pricing of identical or similar items in the vicinity or remotely located can be obtained. This is supported by software that informs the client where in the immediate vicinity that item is in stock and at what price. The client could enter a request and be linked to content and nearby inventory selections. Securely a sender to a vendor request for a good or service package for a specified recipient remote or nearby a sender can be made securely. A vendor is notified of a request for purchase and electronically responds with pick-up or delivery readiness information and payment mechanisms including electronic payment or cash on pick up or delivery.

In another embodiment a remote sender may electronically go to an Internet site enabled by the invention remote from sender but nearby recipient vendor of good or services. There can be sent a message by a sender or vendor to a recipient to accept or reject a service, pick up a package located at a vendor or one to be delivered to a local depot or kiosk or personal physical or electronically capable physical mailbox. A message or physical package accessible by a clued encryption or other means of electronic verification may be used to enhance the confidentiality and security of the process.

To facilitate the above descriptions depots in public traffic areas or kiosks placed strategically for instance as comer kiosks like conventional mail boxes could be pickup sites for deliveries in that immediate geography by the public themselves or couriers. Packages or documents can to be taken to a depot or in the latter case electronically scanned, transferred or faxed. Payment could be by electronic cash transfer means such as cash credit cards or smart cards directly to the vending apparatus or to authorized personnel. People could electronically shop who do not have computers from depots in malls at kiosks or from a remote home or office based physical electronic mail box devices, computers or Internet capable appliances.

In all embodiments of the invention the software and where applicable hardware and combinations thereof may reside on client and server computer hardware or solely on client computer hardware or solely on server computer hardware. Appliances that function in limited ways like computers may be substituted for client or server hardware. Combination networks of servers or servers and clients or client networks may carry or relate to one another wherein software may reside in any combination of physical hardware and appliances.

### BRIEF DESCRIPTION OF THE DRAWINGS

FIG. 1(a) is an overall system architecture of one embodiment of client side elements of the present invention.

FIG. 1(b) is an overall system architecture of one embodiment of server side elements of the present invention.

FIG. 2 is a flow chart illustrating one embodiment of a registration process of the present invention.

FIG. 3 is a flow chart illustrating one embodiment of an authentication process of the present invention.

FIG. 4(a) is a flow chart illustrating one embodiment of a private key encryption process of the present invention.

FIG. 4(b) is a flow chart illustrating one embodiment of a private key decryption process of the present invention.

FIG. 4(c) is a flow chart illustrating one embodiment of a file encryption and upload process.

FIG. 5 is a flow chart illustrating one embodiment of a client to recipient confidential mailing and transaction process.

### DETAILED DESCRIPTION

It is often necessary to transfer or store documents in such a way that they are physically safe (archived), indelible, and readable only by authorized third parties. Further, a computer system enabling these capabilities should be easy to use, and should be based upon technologies already well understood by the user community to allow for widespread use. The present invention addresses this problem by describing a computing system which enables users to indelibly and reliably store and retrieve files in an encrypted state on a remote storage media using a web browser to perform the encryption, decryption, and transfer operations. The web browser-based application may appear to the user to be a web-based file archiving tool, or may appear to be a web-based email tool. Futher, the encryption/decryption functionality may be enabled using either symmetric or asymmetric algorithms. The implementation described herein utilizes mainly asymmetric cryptographic algorithms. However, symmetric cryptographic algorithms may be substituted for much of the asymmetric algorithms, although implementation of only symmetric algorithms results in a loss of capability for the invention. This is because asymmetric algorithms are required to enable digital signatures, which form a fundamental part of the fully functional system. Thus, those skilled in the art may readily determine where either asymmetric or symmetric algorithms will suffice, and where asymmetric-only algorithms are required.

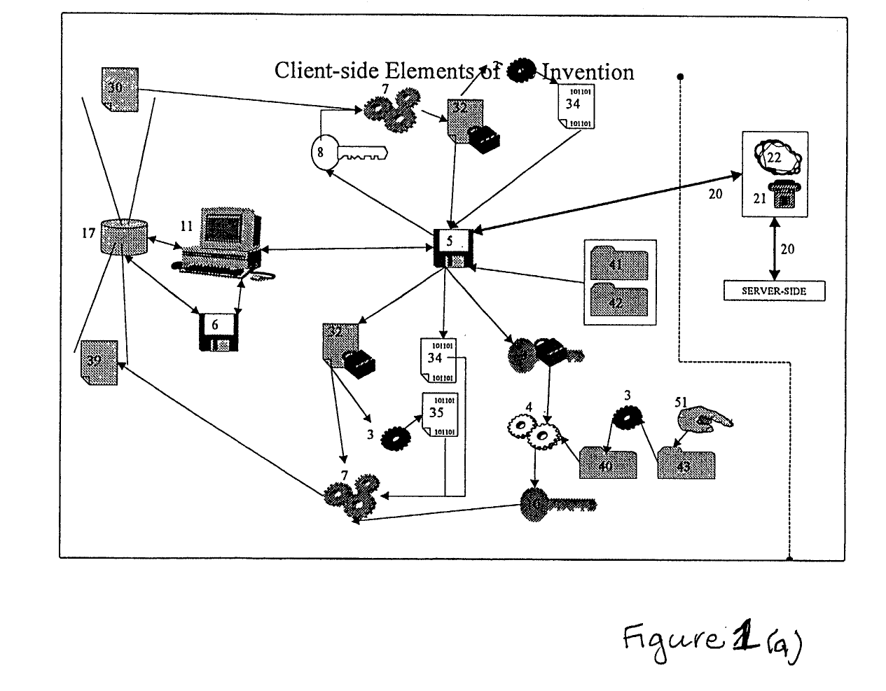

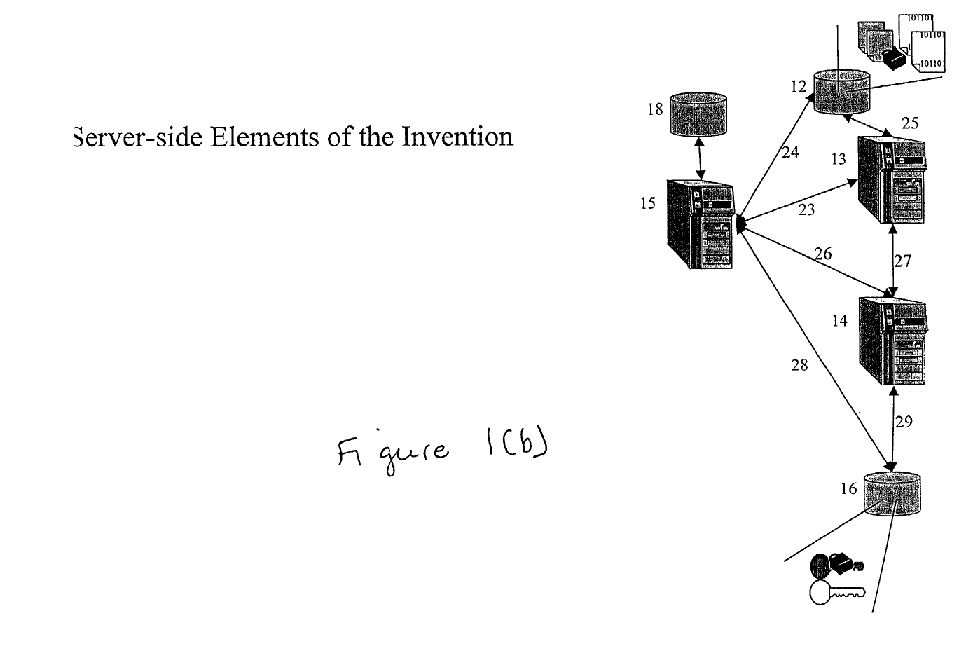

Referring to FIG. 1, a file 30 is located on a client computer 11. It is desired to place the file 30, in an encrypted state on a data server 13. The client 11 and the server 13 may be physically separated by any distance, and need infrastructure in place such as a dialup connection 21 or an Internet protocol connection 22, such that they may establish a communication channel 20. The client 11 initiates communication with the web server 15 using a web browser 5. The web server 15 communicates with the data storage unit 12 and the data server 13, as well as the key server 14. The data server 13, key server 14, and web server 15 are software server applications that may run on one or more computing platforms. They needn't run on separate computer platforms, although in the preferred embodiment system performance and security may be enhanced if they are run on separate computer platforms. The web server 15 may communicate directly with the data storage unit 12, or indirectly with the data storage unit 12 via the data server 13. The only required server module is the web server; key server and data server functionality may be integrated directly with the web server, or may be implemented as stand-alone server modules. Similarly, the logical structure for data, key, and other information storage on the servers may be take on any number of forms well known to those skilled in the art.

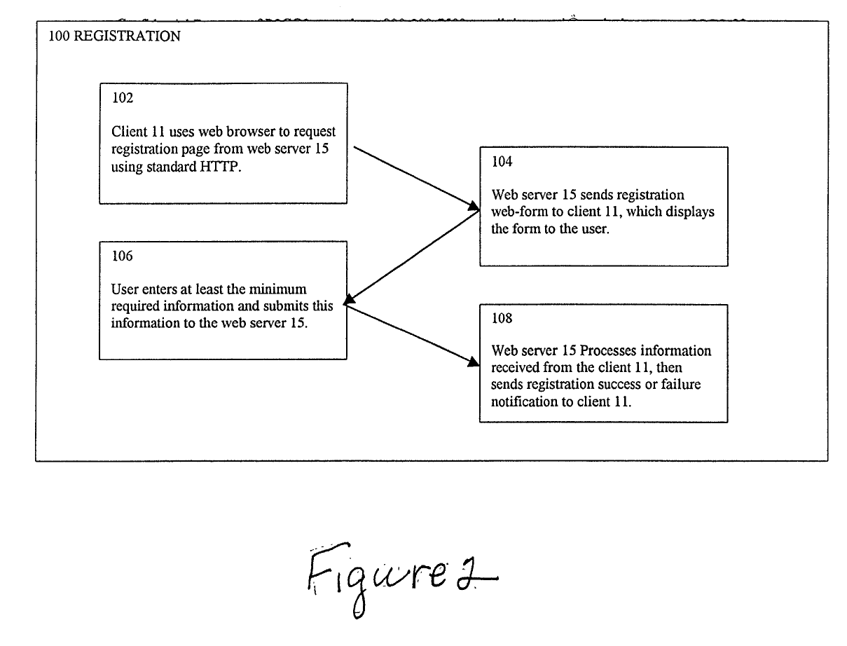

To establish an account with the system, a user is required to follow the registration process 100 as illustrated in FIG. 2. The client 11 establishes a connection to the web server 15 using standard HTTP, and requests 102 the registration page from the server. The web server responds 104 in the standard fashion, sending the web registration form back to the client 11, which then displays the form to the user. The user then enters at least the minimum required information, and uses the client 11 to submit 106 that information to the web server 15, utilizing a Secure Socket Layer (SSL) to ensure confidentiality of the submitted information. The minimum required information varies with different embodiments of the system, and with different uses of the same embodiment of the system. It is expected that, with most embodiments, the user will be required to submit (or will be assigned) at least a username 41, password 42, and keyphrase 43.

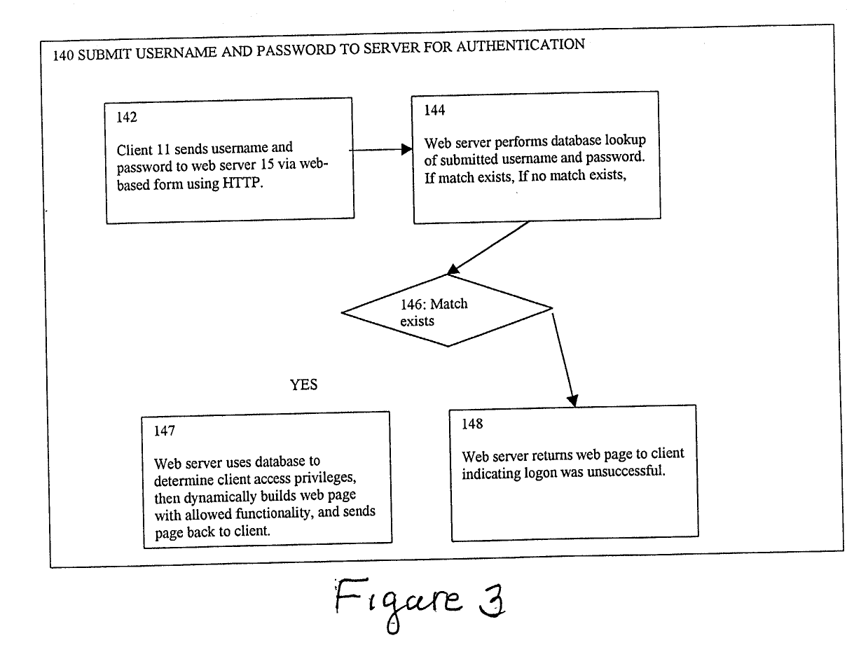

Referring to FIG. 3, the username 41, password 42, and keyphrase 43 may, depending upon the embodiment of the system, be selected by the user or by one of the servers. The utility of the username 41 and password 42 is to allow the user access to the system. By sending 140 a username 41 and password 42 to the system via a web form, or by any number of authentication protocols that are commonly known to those skilled in the art, the system may determine a user's rights to utilize the system and to access various system functions. In the preferred embodiment, the client 11 sends the username and password to the web server 15 via a web form 142. The web server performs a database lookup against the submitted username and password 144 (Note that to provide higher security, the database may actually store a cleartext username and an encrypted password; thus to perform a database lookup the username and encrypted password would be used). If a match is found the web server uses the database to determine the client's access privileges, and dynamically builds the user's home page which allows these privileges 147. If no match exists in the database, a web page is returned to the client indicating that logon failed 148. To prevent unauthorized logon to the system by hackers submitting a large number of usernames and passwords, the web server may include in process 140 a script which blocks, for a specified time period, logon attempts for usernames which have submitted incorrect passwords several times in a row.

As part of the registration process, a code component will generate a public-private keypair. This code component may reside on the server or on the client, depending upon the specific embodiment. The public key will be transferred for storage in the Key Storage Unit 16. The private key will be encrypted using the keyphrase (as described below) and then transferred for storage in the Key Storage Unit 16. Depending upon the implementation, the keyphrase may or may not be stored on one of the servers. Storing the keyphrase may be useful in case a user forgets his keyphrase; without it, any data encrypted is useless and unrecoverable. However, storage of the keyphrase anywhere (except in the user's mind) may enable a third party to decrypt the user's data.

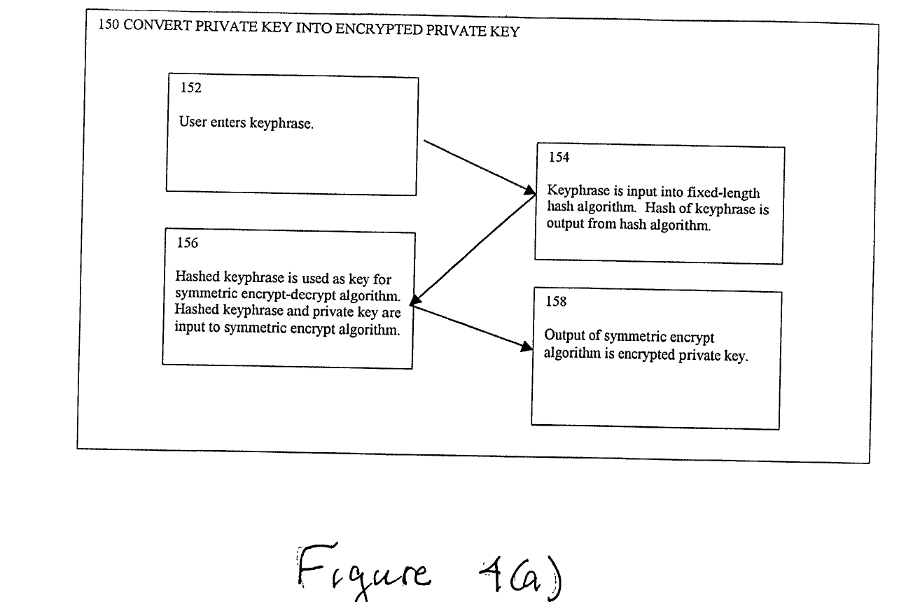

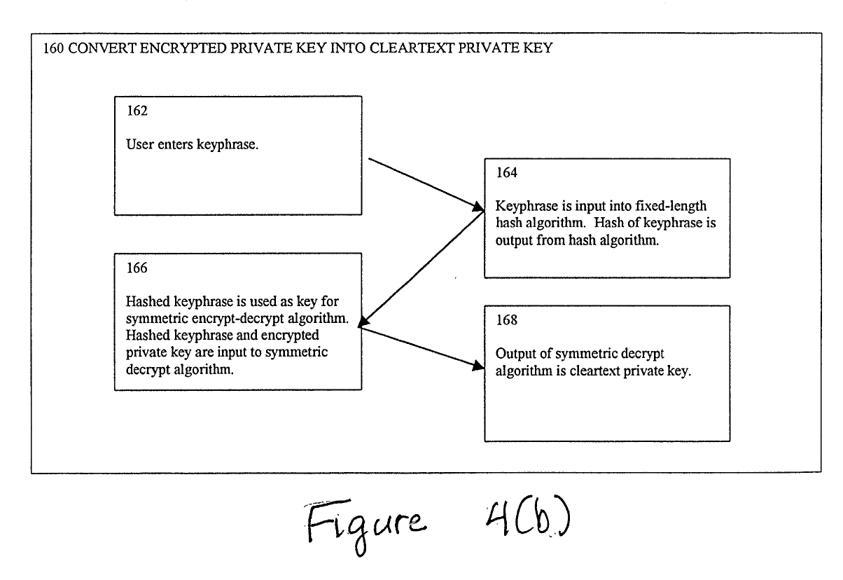

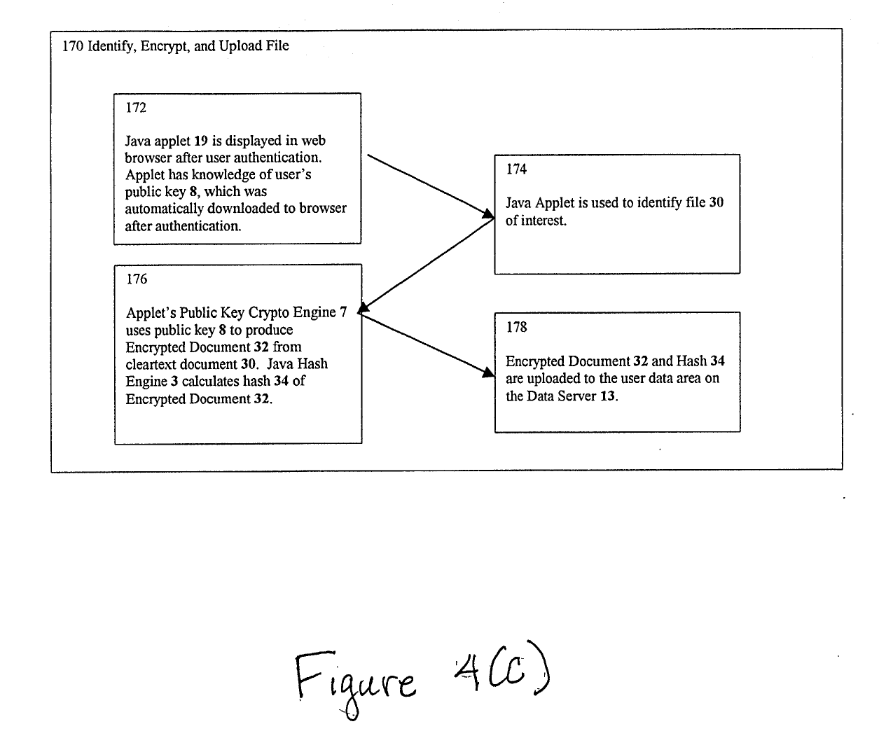

Referring to FIGS. 4(a) and 4(b), a keyphrase 43 is used to convert 150 a private key 10 into an encrypted private key 9, and to convert 160 an encrypted private key 9 into a private key 10.

The private key may be converted into an encrypted private key in any number of ways commonly known to those skilled in the art. In the preferred embodiment, the keyphrase is used as input to a fixed-length hash algorithm 154. The output of the hash algorithm is always a sequence of bits of a predetermined length, the contents of which vary depending upon the keyphrase that was used as input to the algorithm. The hash of the keyphrase may then be used as the key for a symmetric encrypt-decrypt algorithm 156. There are many symmetric algorithms that are suitable for this function. In this way, the cleartext private key is converted into an encrypted private key 158, with the hash of the keyphrase serving as the key to the encrypt-decrypt process.

The encrypted private key may be converted into a cleartext private key in any number of ways commonly known to those skilled in the art. In the preferred embodiment, the keyphrase is used as input to a fixed-length hash algorithm 164. The output of the hash algorithm is always a sequence of bits of a predetermined length, the contents of which vary depending upon the keyphrase that was used as input to the algorithm. The hash of the keyphrase may then be used as the key for a symmetric encrypt-decrypt algorithm 166. In this way, the encrypted private key is converted into a cleartext private key 168, with the hash of the keyphrase serving as the key to the encrypt-decrypt process.

Once the user is authenticated he is presented with a variety of tasks he can accomplish using the system. Most of these tasks utilize code components. The main component is the User Application 19. This application displays a Graphical User Interface (GUI) which provides point-and-click functionality within the web browser 5. Other components include: the Public Key Crypto Engine 7, the Symmetric Key Crypto Engine 4, and the Hash Engine 3. These engines may exist as physically distinct components, or may be embedded within the same code module. These engines may be implemented in a wide variety of ways. The most important aspects of these applications are not the particular implementation, but the contained functionality. For instance, the Crypto Engines may use one or more of many possible encryption algorithms; the key feature is the crytography that is enabled, not the particular algorithm used. Likewise, the Graphical User Interface of the User Application may be designed to look significantly different between two implementations; the key feature is that this component allows graphical access to the functionality contained in that and in other engines.

As illustrated in FIG. 4(c), after authentication 140, files may be identified, encrypted, and uploaded to the dataserver via process 170. The user first indicates his desire to upload a document by clicking a link on his user home page. components are then downloaded to a browser to enable file selection, encryption, and uploading. Using the User Application 19, the user may “browse” his local directory structure to identify the file of interest. Once the user has selected a file, the succeeding steps of the process may be accomplished automatically, or they may be accomplished under the user's direct command. In the preferred embodiment, all processes occur automatically once the user has selected the file of interest. Next, the user's Public Key 8 and the cleartext Document 30 are input to the Public Key Crypto Engine 7; the result of this operation is the Encrypted Document 32. The Encrypted Document 32 is then passed through the Hash Engine to produce a Hash of the Document 34. Both the Document Hash 34 and the Encrypted Document 32 are then stored to the user's private data area on the Data Server 13.

Once authenticated 140, the user may choose to view the contents of his private storage area on the data storage unit 12 by selecting the appropriate link on his user home page. If the user selects an encrypted file for downloading to his local system, his encrypted private key 9, the Hash 34 of the encrypted document, and the encrypted document 32 are downloaded to his local machine. The user inputs 51 his keyphrase 43 into the User Application 19, which completes the remaining steps automatically and without further user intervention (note that the User Application may be implemented in such a way to allow the user to control various intermediate steps of the decryption process). The keyphrase 43 is input to the Hash Engine 3, which produces a Hashed Keyphrase 40. The Hashed Keyphrase 40 is input into the Symmetric Crypto Engine 4, along with the Encrypted Private Key 9. If the keyphrase was correctly input, the result of this operation is the Cleartext Private Key 10. The Encrypted Document 32 is then passed through the Hash Engine to produce a Hash of the Retrieved Encrypted Document 35. The Public Key Crypto Engine compares the Hash of the Retrieved Encrypted Document 35 to the Hash of the Original Encrypted Document 34. If these are identical, it can be assumed that a third party has not altered the Encrypted Document 32 either accidentally through the uploading/downloading process or intentionally. The Cleartext Private Key 10 and the Retrieved Encrypted Document are finally passed through the Public Key Crypto Engine 7 to produce the Decrypted Document 39.

Possible failure modes of the above process include incorrect input of the keyphrase and non-matching Hashes 34 and 35. If the user incorrectly input the keyphrase, the process will continue to completion, however the result will not be the Decrypted Document 39, but instead will result in unintelligible characters. If the Hashes 34 and 35 are found to not match, the Public Key Crypto Engine will alert the user, via the User Application, that an error has occurred.

Once authenticated 140, the user may then choose to create a semiprivate key to associate with any particular document. The association of a semiprivate key to a document is fundamental to allowing the file to be shared with others while remaining encrypted on the server. Note that there are a tremendous number of ways to design the process of semiprivate key generation and assignment. Once again, the ability to generate the semiprivate key and assign it to a document is at the fundamental essence of the invention. In the preferred embodiment, the Public Key Crypto Engine 7 will generate the semiprivate keys and pass them to the Web server 15 for placement into the Key Storage Unit 16. Note that it is possible to implement key generation on the servers rather than on the clients.

Once the user, has selected a link on his home page to create a semiprivate key, the User Application Engine 19 and Public Key Crypto Engine 7 are downloaded to his machine and User Application Engine 19 is displayed within his browser. The user then instructs the Public Key Crypto Engine 7 to generate a new semi-private key. Depending upon the implementation, the creation and management of semi-private keys may be more or less automatic. At one extreme, the semi-private keys may be treated as one-time-use keys. In this case, the key would be automatically generated for use with a particular document. The public and private keys are produced, the document is encrypted with the public key, and then the public key is discarded. The private key is encrypted with a chosen keyphrase, then the keyphrase is discarded and the encrypted private key is placed into the key storage unit. At the other extreme, the semi-private keys may be treated as “just another set of keys.” In this case, the user would request that a new keypair is generated, then a user may name that key, and to distinguish it from other semi-private keys he has created. Depending upon the implementation, the user may be allowed to select key characteristics, such as key type and key length, or the user may have no choice regarding these key characteristics. After encryption of the private key using the keyphrase, the keyphrase is discarded, and the public and private keys are stored in the key storage unit for later use.

In many implementations, it may be desirable to allow sophisticated users to manage their own semiprivate keys, in which case, the semiprivate keys are just considered additional keypairs to manage. In other cases, it may be desirable to “hide” the real implementation of semiprivate keys to make them appear to the user to be a new kind of key. In this implementation, the user may simply select a document for shared distribution to a third party, and let the engine automatically create the keys, encrypt the document, and discard the public key automatically. The utility of this invention is that the users may simply and easily create new keys at any time, and may use those keys to encrypt data for individuals who do not have access to encryption technology. In this way, users of the invention may implement unilateral encryption, and make secure sharing of important documents simple “for the masses.” Today, to use encryption for document sharing two parties are forced to agree in advance on an encryption software package, buy and install the package, generate and exchange keys, then encrypt and exchange documents. This is a serious impediment to the widespread use of encryption technology. Using the elements of the invention, a user may generate a semiprivate key, encrypt a document, and place that document on a Web site, along with the encrypted private key required to decrypt the document. The only remaining difficulty is to pass the keyphrase to the third party to allow the decryption process to occur. That difficulty is addressed in the next section.

In some circumstances, it may be cumbersome to call or email the third party to tell him what the keyphrase is for a particular encrypted document. Further, these key exchange techniques may prove insecure, revealing the keyphrase to interested parties capable of monitoring standard communications channels. Further, to enable “encryption for the masses,” the technology must be simple to use, and must not require specialized knowledge on the part of the user. To facilitate this, the invention utilizes “clueing” to enable the “silent” and automatic exchange of keyphrases.

Once the user is required to enter a keyphrase for a new private key, the user may also be prompted to enter a cluephrase, the answer to the cluephrase being the keyphrase. For instance, the user may enter “ginger” for a keyphrase, and the cluephrase “what is my dog's name?” The security of the key exchange then depends upon the user choosing a keyphrase and cluephrase such that it is unreasonable that any other party might guess the keyphrase by knowing the cluephrase.

To continue, we assume that the user has selected to produce a semiprivate key for the encryption of a particular document. The user has entered a keyphrase and cluephrase for the semiprivate key. The public component of the semiprivate key is used to encrypt the document, and the encrypted document is then stored in the user's private data area. The user has also entered the email addresses of all users who should be allowed to view the encrypted document. Once the process is complete, emails may be sent to all the receiving parties, informing them to go to a particular Web site to retrieve an encrypted document. Thus, in the simplest user implementation, the user simply selects a document to share, selects a keyphrase and cluephrase, and enters the receiving parties' email addresses to allow secure document exchange with those parties. The process for these receiving parties to view the document is described in the next section.

Once a receiving party is notified via email that there is an encrypted document waiting for him at a particular Web site, the receiving party uses his web browser 5 to view that Web site. Code components (user application, crypto engines, etc) may, depending upon the implementation, be downloaded to the receiving party's browser. The receiving party then selects the option to view a document, and enters the sending party's username, and his own email address. A database lookup then finds any documents stored on the server which are to be made available for viewing by the owner of the input email address, from the username input. The user may then select to view the document that is shown. The receiving party then is shown the cluephrase, and is asked to respond with the keyphrase (the answer to the cluephrase). Since the keyphrase may not have been stored upon the servers (depending upon the implementation), it may not be possible to verify that the correct keyphrase has been entered. Instead the encrypted private component of the semiprivate key is downloaded to the browser, along with the encrypted document 32, and the hash of the encrypted document 34. The keyphrase entered by the receiving party is passed to the one-way fixed-length hash engine 3, which produces a hash of the keyphrase 40. The hash of the keyphrase 40 is then passed to the Symmetric Crypto Engine 4, along with the encrypted private key 9. If the correct keyphrase was originally entered, then the result of this operation is the correct decrypted cleartext private key 10. If the incorrect keyphrase was entered, the result is a bit string of the correct key length, but not corresponding to the key that will properly decrypt the document. The encrypted document 32 is passed through the hash engine 3 to produce a new hash 35 of the encrypted document. The Public Key Crypto Engine compares the new hash 35 and the downloaded hash 34 of the encrypted document. If the hashes do not match, an error occurred, most likely in transmission, and the user is alerted of the error condition. If the hashes match, the decryption process continues. The encrypted document 32 and the cleartext private key 10 are passed to the Public Key Crypto Engine, which uses the key to produce the decrypted document 39, which is then placed on the receiving party's local data storage unit 17. If the incorrect keyphrase was originally entered by the receiving party, the cleartext key 10 used by the Public Key Crypto Engine will be incorrect, and will result in a “decrypted document” which will be unreadable gibberish.

The invention described above has obvious benefits over standard encryption processes, in terms of ease of use and no requirements for user-to-user “handshaking” before exchange of documents. Because all software, keys, and documents are stored and retrieved from internet/intranet servers, the only thing a user needs is a computer with a modern browser and a connection to the internet or his own intranet. The remainder of the system is downloaded dynamically and seamlessly from the servers. While it is possible for a user of the system to distribute encrypted documents to persons who have never used the system, it is also possible for persons who have never used the system to send encrypted documents to particular system users. This process is described in the following section.

Suppose a user would like to receive an encrypted financial analysis from his accountant, but doesn't want to deal with cumbersome encryption packages. Further, the accountant doesn't want to install several encryption packages on his machine to accommodate all his clients who use different packages. Instead, the user may simply tell his accountant to send go to a particular Web site and upload the encrypted document to him. The accountant then uses his browser 5 to view the Web site. He selects an option to upload a document to a system user. Code components are downloaded to his browser, which enable subsequent action. He enters his client's username (or email address) and selects the document to be uploaded. A database lookup on the username (or email address) is used to locate the client's primary Public Key 8, which is stored on the key server 14. The public key 8 is downloaded to the accountant's computer, along with the Public Key Crypto Engine 7. The Public Key Crypto Engine 7 uses the Public Key 8 to encrypt the cleartext document 30, to produce an encrypted document 32. Additionally, the encrypted document 32 is passed to the hash engine 3 to produce a hash 34 of the encrypted document. The hash 34 of the encrypted document and the encrypted document 32 are then uploaded to the user's private data area on the servers. Additionally, the user may be automatically notified via email that a new encrypted document is waiting to be viewed. In this way, users who do not have their own public/private keys, and have no knowledge of other users' public and private keys, may simply send encrypted documents.

Once a user is notified via email that there is an encrypted document waiting for him, he uses his web browser 5 to go to the Web site. Code components (user application, crypto engines, etc) may, depending upon the implementation, be downloaded to the user's browser. The user may then select to view uploaded documents, and may be shown all documents waiting to be viewed. The users may select an encrypted document 32 to view. The private key is downloaded to the browser, along with the encrypted document 32, and the hash of the encrypted document 34. The user enters his keyphrase, which is passed to the one-way fixed-length hash engine 3, which produces a hash of the keyphrase 40. The hash of the keyphrase 40 is then passed to the Symmetric Crypto Engine 4, along with the encrypted private key 9. If the correct keyphrase was originally entered, then the result of this operation is the correct decrypted cleartext private key 10. If the incorrect keyphrase was entered, the result is a bit string of the correct key length, but not corresponding to the key that will properly decrypt the document. The encrypted document 32 is passed through the hash engine 3 to produce a new hash 35 of the encrypted document. The

Public Key Crypto Engine compares the new hash 35 and the downloaded hash 34 of the encrypted document. If the hashes do not match, an error occurred, most likely in transmission, and the user is alerted of the error condition. If the hashes match, the decryption process continues. The encrypted document 32 and the cleartext private key 10 are passed to the Public Key Crypto Engine, which uses the key to produce the decrypted document 39, which is then placed on the user's local data storage unit 17. If the incorrect keyphrase was originally entered by the receiving party, the cleartext key 10 used by the Public Key Crypto Engine will be incorrect, and will result in a “decrypted document” which will be unreadable gibberish. In this way, the user may directly download encrypted documents sent to him by persons who are not bona fide system users.

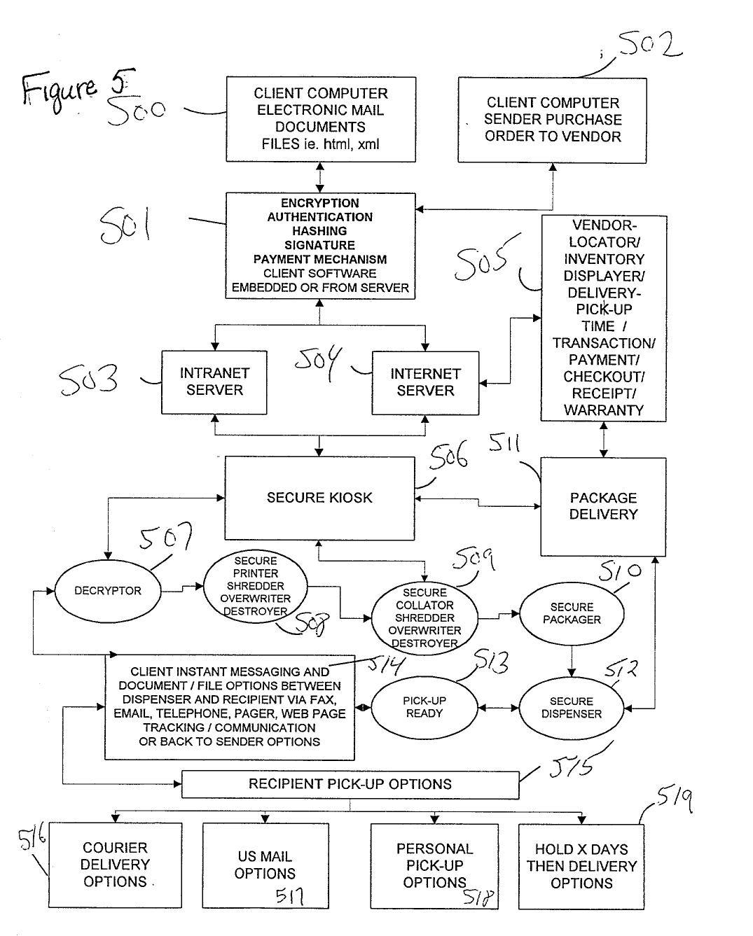

FIG. 5 depicts the systems for creation of documents that are to be securely distributed and a parallel system which goes then into a final common pathway series distribution system similar to the document distribution system. FIG. 5 depicts creation of documents or files using standard software like linux, html, and xml. FIG. 5 then uses the above described processes to encrypt, authenticate, hash, electronically sign and electronically pay for services or goods that may be requested electronically. That information is passed to an intranet server 503 to be relayed to an Internet server 504 or it may go directly from the client to the Internet 504. The software that allows steps 500 and 501 may reside on a client computer or the client may obtain these capabilities from an intranet server 503 or an Internet server 504. If document or other mailings are requested the transfer electronically be relayed in its secure form to the secure kiosk computer 506. Similarly the client may be requesting a purchase order as shown in step 502. The request may then be relayed through the internet as above shown sequentially as steps 502 to 501 to 503 to 504 or directly to 504 leading to step 505. The requester may obtain information about nearby or remote vendors that may have an item or a similar item immediately available or at some determinable time available. In step 505 options are available for communication between a requester and a vendor. Payment, pick-up or delivery times along with transaction related secure documents might be securely relayed between steps 502 and 505. A requester may direct a delivery to a secure kiosk by entering that system at any point but here depicted as entering at steps 506 or 512.

The secure kiosk functions for decryption of documents are depicted in step 507. Materials are further protected in step 508 where printing or document overwriting or shredding or chemical destruction may occur if the printer jams and repairs are needed or a request from the originator of the document is relayed. The documents may then be collated at 509 and packaged at 510. Mailed documents or packages may enter the system then at 512. A recipient may pick-up the package at 513 or is informed that it is ready through the mechanisms depicted in 514. Communication from the kiosk or any other computer or through voice mail instructions may return to a sender or vendor if another request or return message is desired. The recipient may though the mechanism in 514 also indicate what pick-up options are desired as for courier delivery in 516 or to be sent on from the kiosk or depot by governmental (United States or any other country public or private physical mail carrier services). Personal pick-up and alternative delayed delivery options are depicted in steps 518 and 519.

The entirety of the system depicted has multiple capabilities for reversing the messages or requests through open but secure messaging process as shown in the flow chart.

The invention described above enables a variety of encryption-enabled resources. For instance, remotely-stored, encrypted files are enabled, along with encrypted messaging. One potential drawback to the encryption-enabled email described above is that the email recipient is required to access the email via a website. The invention includes an additional feature that allows encrypted email to be sent directly to the intended recipient, so that the recipient is not required to go to a website to retrieve the email document. This addition to the invention is described below.

Email sent directly (in an encrypted state) to a user may be implemented in a platform independent manner by making use of the Java Virtual Machine which is included with every modem web browser, and will be available on the recipient's machine. The sender may directly send encrypted email by selecting that option from his user home page. Components are then downloaded to the sender's browser which enable the sender to enter the email address, text message, attachments, keyphrase, and cluephrase. Since the email will be sent directly to the recipient, the public key infrastructure on the servers will not play a role in the encryption/decryption process. Instead, the Symmetric Crypto Engine, which contains symmetric crypto algorithms, will be used to encrypt the message and attachments. The encryption process begins when the Hash Engine produces a fixed-length hash of the keyphrase to be used as a symmetric encryption key. The text message and attachments are individually encrypted using the hashed keyphrase and the Symmetric Crypto Engine. The encrypted message and documents are then concatenated to form a byte-stream data message. At the beginning of this byte-stream data message, values reflecting characteristics of the encrypted text message and the encrypted documents are concatenated. Java code is then concatenated to the front of the byte-stream data message, to form the complete message. This Java Code implements a self-contained decryption engine which is capable of extracting the byte-stream data message, receiving a keyphrase, and carrying out all steps required to decrypt and display the message. The step of concatenating the Java Code to the byte-stream data message may occur either on the sender's machine, or on one of the servers after the byte-stream data message is uploaded. In the end, one of the servers will possess a complete message (consisting of Java Code, message characteristics, encrypted text message, and the encrypted documents), a recipient's email address, and a cluephrase. This is packaged into a standard email, which contains standardized text indicating that this is an encrypted message, along with the text of the cluephrase. The complete message is sent as an attachment to the email to the recipient. Once received, the recipient “opens” the attachment. This results in the recipient's Java Virtual Machine being loaded, which begins to read the complete message. A user interface is displayed which allows the recipient to enter the keyphrase. The Java Code (which contains the decryption engine as well as the hash engine) then hashes the keyphrase and uses that hash to decrypt the accompanying byte-stream data message. Finally, the user interface allows the recipient to save/display the decrypted message text, and save the decrypted attached documents.

What is claimed is:

1. A method of secure data transmission over an unsecured network, comprising:
(a) linking a first local terminal to a server via the network;
(b) signaling to the server from the first local terminal that a secure transmission of a data document resident on the first local terminal is desired;
(c) downloading an encryption applet resident on the server into random access memory on the first local terminal;
(d) encrypting the data document using the encryption applet to create an encrypted data document on the first local terminal;
(e) uploading the encrypted data document from the first local terminal to the server via the network;
(f) linking a second local terminal to the server via the network;
(g) signaling to the server from the second local terminal that a secure transmission of the encrypted data document on the server is desired;
(h) downloading the encrypted data document from the server to the second local terminal;
(i) downloading a decryption applet resident on the server into random access memory on the second local terminal; and
(j) decrypting the encrypted data document using the decryption applet to recreate the data document on the second local terminal.

2. The method of claim 1, wherein step (a) further comprises authentication of the first local terminal; and step (g) further comprises authentication of the second local terminal.

3. The method of claim 1, wherein steps (b), (c), (d) and (e) are initiated and carried out by a single command from the first local terminal, and steps (g), (h), (i) and (j) are initiated and carried out by a single command from the second local terminal.

4. The method of claim 1, further comprising:
(k) deleting the encryption applet from the random access memory on the first local terminal; and
(l) deleting the decryption applet from the random access memory on the second local terminal.

5. The method of claim 3, wherein steps (b), (c), (d), (e) and (k) are initiated and carried out by a single command from the first local terminal, and steps (g), (h), (i), (j) and (l) are initiated and carried out by a single command from the second local terminal.

6. The method of claim 1, further comprising:
(m) downloading a hashing applet resident on the server into random access memory on the first local terminal;
(n) creating a hash of the encrypted data document using the hashing applet on the first local terminal;
(o) uploading the hash of the encrypted data document from the first local terminal to the server via the network;
(p) downloading the hash of the encrypted data document from the server to the second local terminal via the network;
(q) downloading the hashing applet resident on the server into random access memory on the second local terminal;
(r) creating a second hash of the downloaded encrypted data document using the hashing applet on the second local terminal;
(s) comparing the first hash of the encrypted data document and the second hash of the downloaded encrypted data document on the second local terminal; and
(t) displaying an error message on the second local terminal if the first hash of the encrypted data document does not match the second hash of the downloaded encrypted data document.

7. The method of claim 1, further comprising:
(u) deleting the hashing applet from the random access memory on the first local terminal; and
(v) deleting the hashing applet from the random access memory on the second local terminal.

8. The method of claim 6, further comprising:
(w) designating a keyword on the first local terminal;
(x) creating a hash of the keyword using the hashing applet on the first local terminal;
(y) encrypting the data document in step (d) using the hash of the keyword as an encryption key;
(z) creating a keyphrase as a clue to the keyword;
(aa) communicating the keyphrase to an intended recipient of the data document;
(bb) entering the keyword corresponding to the keyphrase on the second local terminal;
(cc) creating a second hash of the keyword using the hashing applet on the second local terminal;
(dd) decrypting the encrypting the data document in step (j) using the second hash of the keyword as a decryption key.

9. The method of claim 8, wherein at least one of the first and second local terminals is located in a publicly accessible location and connected to a means for recording the data document in a tangible medium.

10. The method of claim 9, wherein the means for recording the data document in a tangible medium includes a means for erasing, overwriting and/or destroying the data document on the tangible medium upon detection of an error or incomplete transaction.

11. The method of claim 1, wherein at least one of the first and second local terminals is located in a secured business location and connected to a means for recording the data document on a tangible medium.

12. The method of claim 11, further comprising delivering the data document recorded on the tangible medium from the secured business location to an intended recipient.

13. The method of claim 6, further comprising:
(w) designating a keyword on the first local terminal;
(x) combining the keyword with a public or private key to create a semi-private encryption key;
(y) creating a hash of the semi-private encryption key using the hashing applet on the first local terminal;
(z) encrypting the data document in step (d) using the hash of the semi-private encryption key as an encryption key;
(aa) creating a keyphrase as a clue to the keyword;
(bb) communicating the keyphrase to an intended recipient of the data document;
(cc) entering the keyword corresponding to the keyphrase on the second local terminal;
(dd) combining the keyword with the public or private key to recreate the semi-private encryption key;
(ee) creating a second hash of the semi-private encryption key using the hashing applet on the second local terminal;
(ff) decrypting the encrypting the data document in step (j) using the second hash of the semi-private encryption key as a decryption key.
